(19) United States
(12) Patent Application Publication
(10) Pub. No.: US 2005/0152320 A1
(43) Pub. Date: Jul. 14, 2005

(54) Wireless communication method and apparatus for balancing the loads of access points by controlling access point transmission power levels

(75) Inventors: Paul Marinier, Brossard (CA); Angelo Cuffaro, Laval (CA); Christopher Cave, Candiac (CA); Vincent Roy, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/935,942

(22) Filed: Sep. 8, 2004

Related U.S. Application Data
(60) Provisional application No. 60/535,022, filed on Jan. 8, 2004.

(51) Int. Cl. H04Q 7/24

(52) U.S. Cl. 370/338; 370/349

(57) ABSTRACT

A wireless communication method and apparatus for balancing the loads of access points (APs). A baseline range parameter of a particular one of the APs is obtained. The load of the particular AP and the channel utilization on channels not used by the particular AP are estimated and compared to different thresholds. The range of the coverage area of the particular AP is adjusted depending on the results of the comparisons. The transmission power level of the AP is determined by summing the AP range adjustment with a required received power (RRP) value. The range (i.e., transmission power level) of a particular AP with a light load is increased if the load on at least one channel used by another AP is heavy, and the range of a particular AP with a heavy load is decreased if the load on all channels not used by the particular AP is light.

### CROSS REFERENCE TO RELATED APPLICATION

This application claims priority from U.S. Provisional Application No. 60/535,022, filed Jan. 8, 2004, which is incorporated by reference as if fully set forth herein.

### FIELD OF INVENTION

The present invention relates to a wireless communication system including a plurality of access points (APs). More particularly, the present invention relates to a method and apparatus for balancing loads of the APs by controlling the transmission power levels of the APs.

### BACKGROUND

Wireless local area networks (WLANs) have become more popular because of their convenience and flexibility. Such networks typically include an AP and a plurality of wireless transmit/receive units (WTRUs) which wirelessly communicate with one another.

As new applications for such networks are being developed, their popularity is expected to significantly increase. Institute of Electrical and Electronics Engineers (IEEE) working groups have defined an IEEE 802.11 baseline standard having extensions which are intended to provide higher data rates and other network capabilities.

In an environment where several APs are deployed, a WTRU may potentially associate (i.e., communicate) with any particular AP from which it receives and decodes a beacon packet and other types of packets, such as probe responses or the like. However, situations often occur where a number of WTRUs are located in the vicinity of a particular AP. For example, an AP located in a conference room full of WTRU users attempting to access the wireless medium would become overloaded and thus provide significantly degraded services, (in terms of throughput and delay), to the WTRU users.

A method and system for preventing an AP from being overloaded when it is in the vicinity of too many WTRU users is desired.

### SUMMARY

The present invention is related to a wireless communication method and apparatus for balancing the loads of APs by controlling the transmission power levels of the APs. The apparatus may be a wireless communication system, an AP, a WTRU or an integrated circuit (IC).

In accordance with the present invention, a baseline range parameter of a particular one of the APs is obtained. The load of an AP within its intended coverage area is estimated and compared to different thresholds. The load on channels not used by the AP is also estimated and compared to different thresholds. A processor performs a load balancing process by adjusting the range of the AP coverage area depending on the results of these comparisons. The range of the AP is increased if the load of this AP is below a threshold while the channel utilization on one of the other channels is above a threshold. The range of the AP is decreased if the load of this AP is above a threshold while the channel utilization on the other channels is above a threshold. The threshold values used may be different.

In order to maintain satisfactory performance within the coverage area of the APs, the transmission power levels of the APs are determined by summing their respective AP range adjustments with required received power (RRP) values associated with the minimum power level at which a particular type of packet transmitted by a respective AP is expected to be successfully received by a respective WTRU. The range (i.e., transmission power level) of APs with light loads is increased if the load on at least one other channel (used by other APs) is heavy, and the range of APs with heavy loads is decreased if the load on the other channels (used by other APs) is light.

Optionally, if any particular one of the WTRUs is determined to have an out-of-range status, the particular WTRU may be disassociated with its current serving AP, and any association request received from the particular WTRU is denied. The present invention may be implemented in a WLAN.

The present invention is particularly useful when applied to establishing power levels and range adjustments on systems with multiple APs, and may be used in systems which utilize data hot spots to communicate a large amount of data through localized APs.

### BRIEF DESCRIPTION OF THE DRAWINGS

A more detailed understanding of the invention may be had from the following description, given by way of example and to be understood in conjunction with the accompanying drawings wherein:

FIG. 1 shows the parameters used by a power control process to determine the transmission power level of an AP in accordance with one embodiment of the present invention;

FIG. 2 is a flow diagram of a power control process in accordance with the present invention;

FIG. 3 is a diagram of the application of load balancing in accordance with the present invention; and

FIG. 4 is a flow diagram of performing a range adjustment in accordance with the present invention.

### DETAILED DESCRIPTION OF THE PREFERRED EMBODIMENTS

Hereafter, the terminology “WTRU” includes but is not limited to a user equipment (UE), mobile station, fixed or mobile subscriber unit, pager, or any other type of device capable of operating in a wireless environment.

When referred to hereafter, the terminology “AP” includes but is not limited to a base station, a Node-B, site controller or any other type of interfacing device in a wireless environment. The invention is particularly applicable to wireless local area networks (WLAN).

The present invention will be described with reference to the drawing figures wherein like numerals represent like elements throughout. The present invention applies as an add-on to the WLAN IEEE 802.11 standards (802.11 baseline, 802.11a, 802.11b, and 802.11g), and also applies to IEEE 802.11e, 802.11h and 802.16.

The present invention may be further applicable to Time Division Duplex (TDD), Frequency Division Duplex (FDD), and Time Division Synchronous CDMA (TD-SCDMA), as applied to a Universal Mobile Telecommunications System (UMTS), CDMA 2000 and CDMA in general, but is envisaged to be applicable to other wireless systems as well.

The features of the present invention may be incorporated into an IC or be configured in a circuit comprising a multitude of interconnecting components.

If neighboring APs utilizing other frequency channels are deployed at locations sufficiently close to that of an overloaded AP, the performance of all WTRUs may be dramatically improved if some of the WTRUs associate to these neighboring APs in place of the overloaded AP. By controlling the transmission power level of an AP, and especially the transmission power level of the beacon and probe response packets, it is possible to control the extent of area around the AP from which WTRUs can associate to this AP. When a severe load imbalance exists among a plurality of APs, the loads of the APs can be balanced by appropriately adjusting the transmission power levels of the APs, such that an overloaded AP reduces its transmission power level and a lightly loaded AP increases its transmission power level.

The present invention provides a wireless communication method and apparatus which adequately serves associated WTRUs within a predetermined region or coverage area around an AP, taking into account possible interference experienced by the WTRUs. Although the present invention can work with inter-AP signaling, as described hereafter and under the current assumptions, no inter-AP signaling exists.

According to the present invention, the extent of a baseline coverage area is defined for each AP, and is applied to situations where no severe load imbalance exists between APs. This baseline range is defined in terms of a maximum path loss (“baseline range”) between a WTRU and the AP, such that the WTRU experiences satisfactory performance. The baseline range can be specified directly by a person deploying the WLAN, or determined automatically by the APs based on path loss measurements or other measurements.

The mitigation of load imbalances between basic service sets (BSSs) addresses a practical scenario where a large number of WTRUs find themselves concentrated in a specific area, such as in a conference room or a “hot spot.” In this scenario, transmission power adjustments for beacon, probe response and other types of packets can favor load balancing by making some APs appear more or less attractive for association from the point of view of WTRUs.

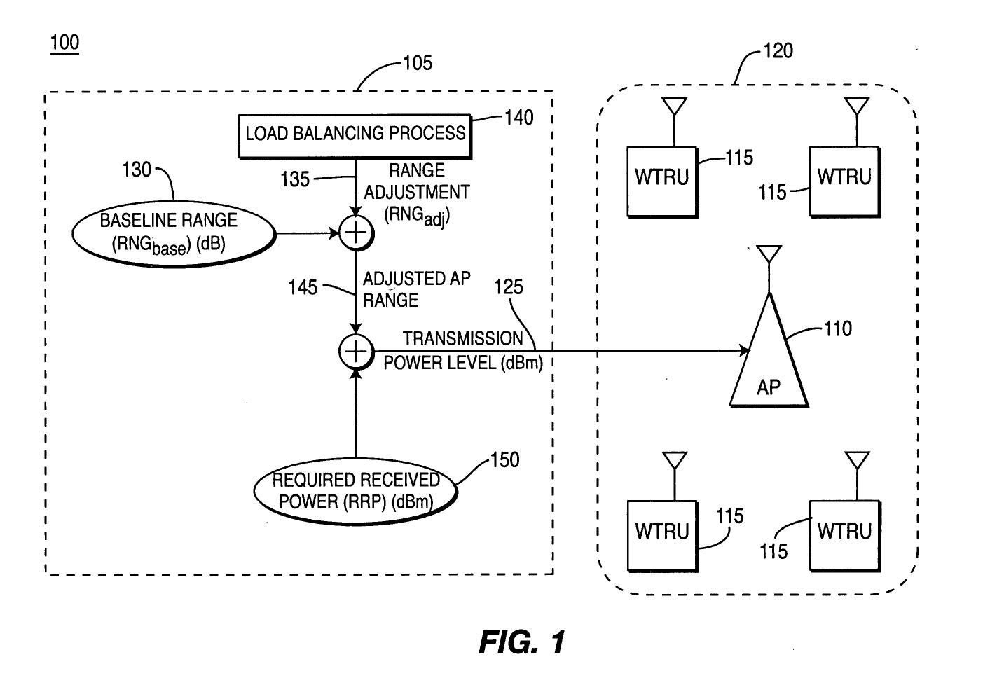

FIG. 1 shows a wireless communication system 100 which implements a power control process 105 in accordance with the present invention. The power control process may run on a processor (not shown) located in the system 100 that controls the AP 110. The wireless communication system includes at least one AP 110 which communicates with a plurality of WTRUs 115 located within an AP coverage area 120. The power control process 105 determines the transmission power level 125 of the AP.

In the power control process 105 of FIG. 1, a baseline range (RNG_{base}) parameter 130 is obtained either directly by a manual configuration or using an automated process. The RNG_{base} parameter 130 delimits the extent of the desired coverage area 120 of the AP 110 when no severe load imbalance exists between the AP 110 and other APs (not shown). The transmission power level 125 of the AP 110 is set so that WTRUs 115 located within the coverage area 120 have an acceptable path loss. The RNG_{base} parameter 130 is summed with a range adjustment parameter (RNG_{adj}) 135 determined by a load balancing process 140 according to the load of the AP 110, resulting in an adjusted AP range 145.

In the power control process 100 of FIG. 1, a required received power (RRP) parameter 150 is also obtained either directly using a manual configuration or by an automated process. The value of the RRP parameter 150 is set to the minimum power level at which a packet transmitted by the AP 110 may be successfully received by a WTRU 115. The value of the RRP parameter 150 may vary depending on the type of packet (beacon, probe response or the like) and the resulting data rate.

The transmission power level 125 of the AP 110 (in dBm) is determined by summing the value of the adjusted AP range 145 (in dB) with the value of the RRP parameter 150 (in dBm) for the packet to be transmitted, subject to a maximum power limitation.

Table 1 summarizes the variables involved in the setting of the transmission power level 125 of the AP 110. These variables are exemplary, and it should be noted that other variables may be used.

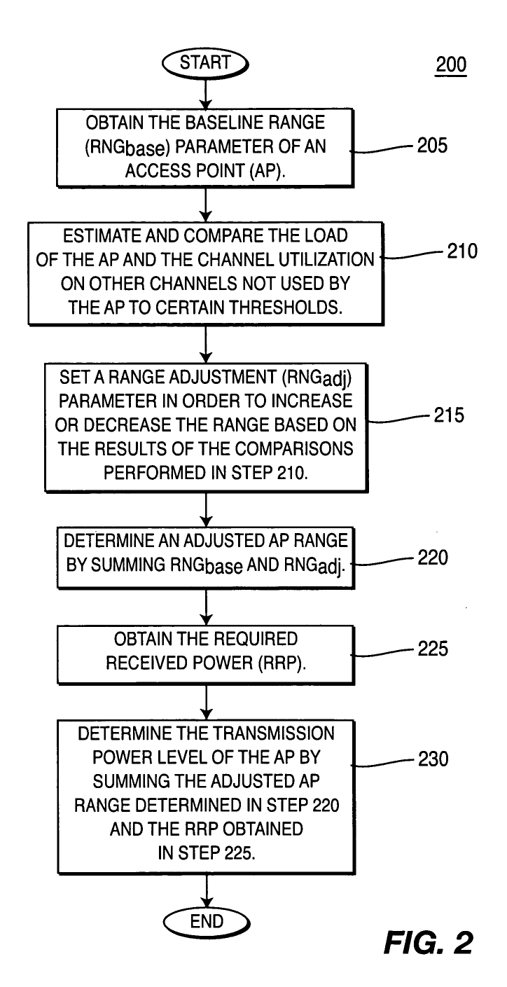

TABLE 1

| Symbol | Description |
|---|---|
| RNG_{base} | Baseline Range |
| RNG_{adj} | Range Adjustment (set using process 200 of FIG. 2) |
| RRP | Required Received Power |
| Pₘₐₓ | Maximum AP transmission power |
| P | AP transmission power, where |
| | P = min (Pₘₐₓ, RNG_{base} + RNG_{adj} + RRP) |

FIG. 2 is a flowchart of a process 200 which implements method steps in accordance with the present invention. An example of the parameters involved in process 200 is presented in the following Table 2. The parameters in Table 2 are suitable for use in an IEEE 802.11b system. The value of the RRP parameter depends on the type and data rate of the transmitted packet, (and therefore different minimum transmission power levels may be applicable to different types of packets).

TABLE 2

| Symbol | Description | Type | Default value | |
|---|---|---|---|---|
| T_{LB} | Periodicity of Load Balancing | Input, configuration | 30 | s |
| PLₘᵢₙ | Minimum Path Loss of the load | Input, configuration | 50 | dB |
| | histogram | | | |
| PLₘₐₓ | Maximum Path Loss of the load | Input, configuration | 115 | dB |
| | histogram | | | |
| Δ_{LPL} | Width of Path Loss bin in load | Input, configuration | 2 | dB |
| | histogram and Range Adjustment | | | |
| | large step size | | | |
| Δ_{SPL} | Range Adjustment small step size | Input, configuration | 0.1 | dB |
| N_{ownload} | Number of own load histograms | Input, configuration | 4 | |
| | averaged in the immediate past | | | |
| N_{chanload} | Number of own load histograms | Input, configuration | 4 | |
| | averaged in the immediate past | | | |
| P_{STA} | Assumed WTRU transmission power | Input, configuration | 17 | dBm |
| C(f) | Channel Utilization of channel f | Input, measurement | N/A | |
| L_{low} | Low threshold for load balancing in | Input, configuration | 20% | |
| | percentage of medium time | | | |
| L_{high} | High threshold for load balancing in | Input, configuration | 40% | |
| | percentage of medium time | | | |
| RNG_{adjmin} | Minimum Range Adjustment | Input, configuration | −30 | dB |
| RNG_{adjmax} | Maximum Range Adjustment | Input, configuration | 30 | dB |
| RNG_{adj} | Range Adjustment | Output, internal | N/A | |
| | | variable | | |
| RRP | Required Received Power | Input, determined | −90 | dBm (for beacon |
| | | from manual | | and probe response |
| | | configuration or | | packets) |
| | | automated process | −84 | dBm (for data |
| | | | | packets) |

The load balancing process 140 uses a histogram of the load in a particular BSS from associated WTRUs as a function of path loss (PL). This is measured during normal operation over a period T_{ownload} by summing the durations of transmitted packets and correctly received packets to/from associated WTRUs whose path loss belongs to the same bin. Path loss is estimated based on the received signal strength indicator (RSSI) of packets received from WTRUs and the assumed WTRU transmission power. The histogram is divided by T_{ownload} to provide results in terms of percentage of medium time. The width of a bin is Δ_{LPL}. Histograms from the past N_{ownload} periods of T_{ownload} are averaged to increase the quality of the statistics.

The method of obtaining the duration of a correctly received packet depends on the chipset capabilities. The chipset may provide directly the duration of a received packet. If this is not available, the chipset may provide the data rate of the received packet. In that case, the duration of the packet may be derived by dividing the number of bits in the medium access control (MAC) packet data unit (PDU) by the data rate and add to this the duration of the physical layer (PHY) header. If this is not available either, the duration of the packet may be derived by measuring the time elapsed between the PHY-RXSTART and PHY-RXEND indications corresponding to the reception of the packet.

From the latter histogram, one defines an in-range load, Lᵢₙ(PL), as the total load in the BSS for path loss values inferior or equal to the variable PL.

Referring to FIGS. 1 and 2, the baseline range (RNG_{base}) parameter 130 of the AP 110 is determined either directly by a manual configuration or using an automated process based on various measurements (step 205). The RNG_{base} parameter 130 may be determined by measuring path loss from the AP 110 to a WTRU 115. The RNG_{base} parameter 130 is preferably set irrespective of the channels used by the neighboring APs. The reasoning behind this approach is that the desired coverage area of an AP is primarily dependent on the locations that the installer has chosen for the set of APs supporting an extended service set (ESS).

Still referring to FIG. 2, in step 210, the load of the AP as well as the channel utilization on other channels is compared to certain thresholds. In step 215, the range adjustment (RNG_{adj}) parameter 135 is adjusted in order to increase or decrease the range based on the result of the comparisons made in step 210. The RNG_{adj} parameter 135 is applied in order to reduce the load imbalance between the AP and its neighboring APs.

Typically, if a lightly loaded AP is adjacent to a heavily loaded AP utilizing a different channel, the lightly loaded AP increases its RNG_{adj}, while the heavily loaded AP decreases its RNG_{adj}. This tends to balance the load between the APs. The RNG_{adj} is not the “step size” of the range adjustment. It represents the difference between the current range, (after all previous adjustments), and the baseline range. For example, if the current range is 96 dB and the baseline range is 90 dB, the range adjustment is 6 dB. If, at the next load balance activation, the range adjustment is increased by Δ_{LPL}=2 dB, the range adjustment is now 8 dB and the current range 98 dB.

In step 220, the value of the adjusted AP range 145 is determined by summing RNG_{base} and RNG_{adj}. In step 225, the RRP for each type of packet is determined either directly by a manual configuration or using an automated process. In step 230, the transmission power level 125 of the AP 110 is determined by summing the value of the adjusted AP range 145 with the RRP 150.

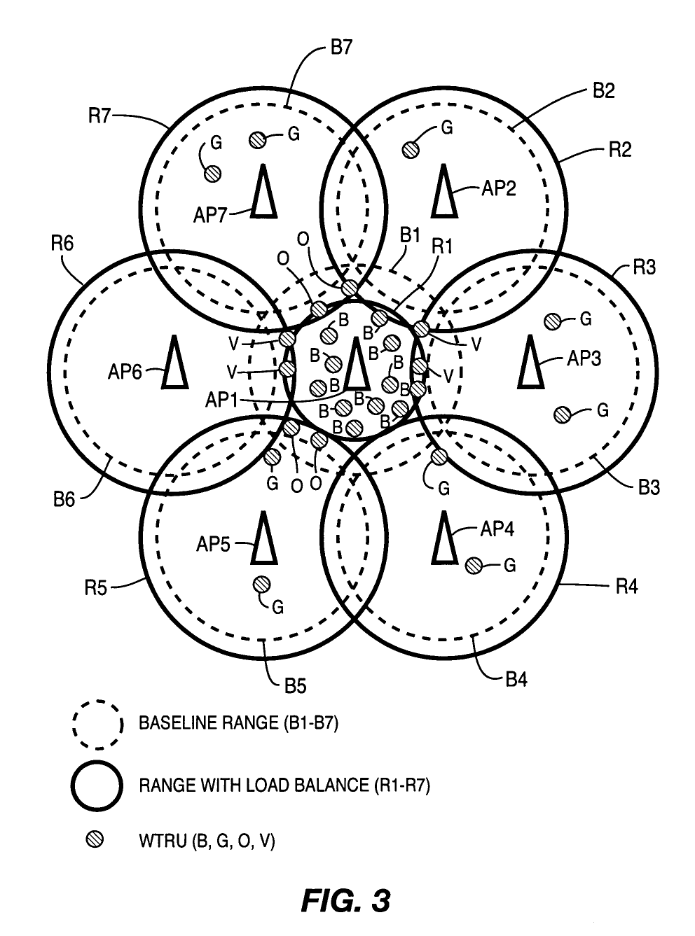

FIG. 3 illustrates a scenario where the load balancing process 140 is used to mitigate congestion occurring in a particular BSS. An AP, AP1, having a baseline range B1 is surrounded by neighboring APs, AP2-AP7, having respective baseline ranges R2-R7. It is assumed here that the center AP (AP1) uses a channel different than the ones used by the surrounding APs (AP2-AP7).

WTRUs are represented by points “O”, “G”, “V” and “B”. WTRUs “G” are associated with the boundary APs. WTRUs “V” and “B” are associated with the center AP, AP1. WTRUs “O” are associated to the boundary APs, AP5 and AP7, because their WTRU-dependent association processes prefer far-away but lightly-loaded APs, AP5 and AP7, over the heavily-loaded closest AP, AP1.

As shown in FIG. 3, the load of the AP, AP1, is heavy compared with those of the other neighboring APs, AP2-AP7, since the density of the WTRUs around the AP, AP1, is considerably higher than the WTRUs around the neighboring APs, AP2-AP7. WTRUs, “O”, “V” and “B”, lie outside the area delimited by the RNG_{base} of boundary APs (AP2-AP7), causing signals received from the APs to fall below the RRP. Therefore, an unacceptable quality in the downlink is experienced due to the severe load imbalances between the AP, AP1, and the neighboring APs, AP2-AP7.

An AP estimates the load in neighboring BSSs using different channels by estimating the channel utilization C(fᵢ) in all frequency channels fᵢ used in the WLAN, (except the one currently used by the AP). These channel utilization estimates can be obtained by intermittently listening to these frequency channels for short periods of time, (i.e., Silent Measurement Periods (SMP)), so that normal communications associated with the AP are not substantially disrupted. The channel utilization represents the fraction of the time the wireless medium is busy, (i.e., used by an IEEE 802.11 device), on this channel. It can be estimated as the total duration of the clear channel assessment (CCA) Busy state during all SMPs on this channel over a T_{chanload} period, divided by the total duration of all SMPs on this channel over a T_{chanload} period. The receiver is in the CCA busy state when it can detect that an IEEE 802.11 type of signal is present at a power higher than a certain threshold.

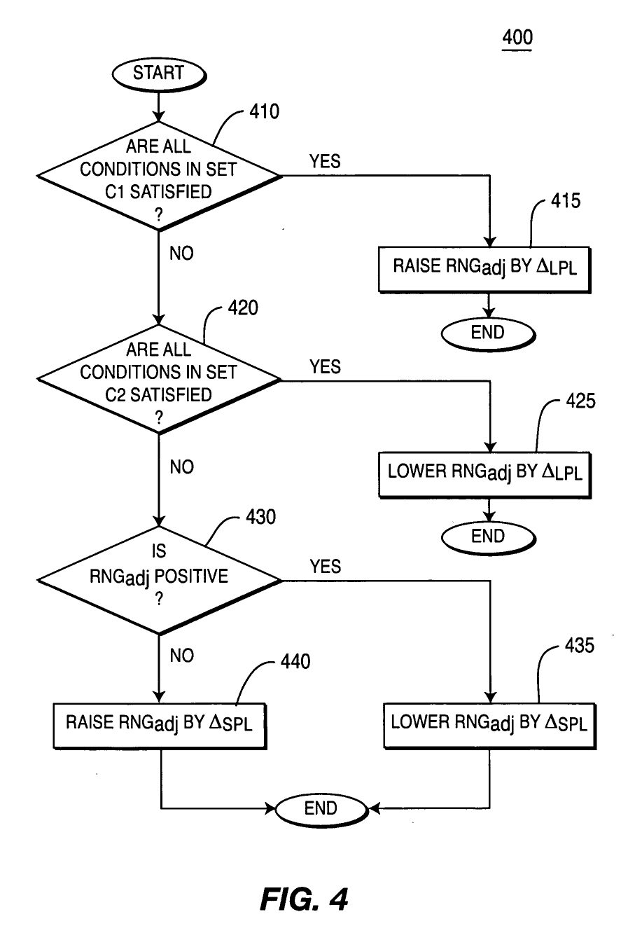

FIG. 4 is a flowchart of a range adjustment process 400. In step 410, it is determined whether all of the conditions in a first set C1 are satisfied (step 410). The conditions in the set C1 include:
1) RNG+Δ_{LPL}≦RNG_{base}+RNG_{adjmax};
2) Lᵢₙ(PL=RNG)<L_{low}, (i.e., the load due to WTRUs whose path losses to the AP are less than RNG should be less than L_{low});
3) Lᵢₙ(PL=RNG+Δ_{LPL})<L_{high}, (i.e., the load due to WTRUs whose path losses to the AP are less than RNG+Δ_{LPL} should be less than L_{high}); and
4) C(f)>L_{high} for at least one channel f (other than the one currently used by this AP) for at least one neighboring AP.

In the above set C1, RNG_{adjmax} is a configurable parameter setting the maximum range adjustment. The condition 1) checks that the range adjustment is not exceeded. L_{low} and L_{high} are also configurable parameters defining thresholds for increasing or decreasing the range, respectively. The condition 2) checks that the in-range load for the current range is below the L_{low} threshold. The condition 3) checks that the in-range load, Lᵢₙ, will not exceed the threshold L_{high} that would result in a range adjustment reduction at the next activation. This is to prevent ping-pong re-adjustments in case the load is dominated by a single WTRU. Finally, the condition 4) checks that the load in at least one of the channels used by neighboring APs exceeds the L_{high} threshold.

If all of the conditions in the set C1 are satisfied, the RNG_{adj} is raised by a large step size Δ_{LPL} (step 415). The large step size Δ_{LPL} is used to modify the range adjustment when a load balancing action needs to take place (increase or reduce the range). A small step size Δ_{SPL} is also used to restore gradually the ranges of the APs to the baseline range in the long term, as will be discussed in further detail below. If all of the conditions in the set C1 are not satisfied, it is determined whether all of conditions in a second set C2 are satisfied (step 420). The conditions in the set C2 include:
1) RNG−Δ_{LPL}≧RNG_{base}+RNG_{adjmin};
2) Lᵢₙ(PL=RNG)>L_{hig};
3) Lᵢₙ(PL=RNG−Δ_{LPL})>L_{low}; and
4) C(f)<L_{high} for all channels f other than the one currently used by this AP.

In the above set C2, RNG_{adjmax} is a configurable parameter setting the minimum range adjustment (this is normally a negative value). The condition 1) checks that the range adjustment is not too low. The condition 2) checks that the in-range load, Lᵢₙ, for the current range is above the L_{high} threshold. The condition 3) checks that the in-range load, Lᵢₙ will not be below the threshold L_{low} that would result in a range adjustment increase at the next activation. The condition 4) is provided to reduce the probability that the AP is off-loading some WTRUs that have no hope of being re-associated successfully because the alternate AP that they could reasonably re-associate with is also overloaded.

If all of the conditions in the set C2 are satisfied, the RNG_{adj} is lowered by Δ_{LPL} (step 425). If all of the conditions in the set C2 are not satisfied, (i.e., if the sets of conditions C1 and C2 are not satisfied), it is determined whether RNG_{adj} is positive (step 430). If RNG_{adj} is positive, RNG_{adj} is lowered by Δ_{SPL} (step 435). If RNG_{adj} is not positive (i.e., it is negative), RNG_{adj} is raised by Δ_{SPL} (step 440). This ensures that even if a change to the range adjustment is not warranted according to the set of conditions in C1 or C2, the range adjustment is still modified by a smaller step in the direction that reduces it in absolute terms, closer to zero. The reason for performing this small correction is to avoid a situation where the range adjustments drift toward values depending more on the specific history of load balancing actions, rather than toward values that optimize the system performance. This situation could arise because the set of conditions under which large range adjustment in sets C1 and C2 are performed are relatively restrictive, with, for example, a large gap between the L_{low} and L_{high} thresholds. This could cause the range adjustment of a particular AP to stay at an unnecessarily low or high value for a long time.

The range adjustment is preferably between −30 dB and +30 dB. The large step size (Δ_{LPL}) is set to, for example, 2 dB, leading to a maximum rate of change for the Range of 4 dB in one minute. A faster rate of change could lead to overshooting given the time necessary for the system to react to range modifications through association/de-association mechanisms. The small step size, Δ_{SPL}, is set to a value, e.g., 0.1 dB, which is substantially smaller than the accuracy of the transmission power setting. However, the goal here is not to increase the accuracy of the transmission power. It is to ensure that over a time frame of one day the system can return to its baseline settings if during that time the traffic conditions stay normal, rather than keep the memory of previous events of load imbalance.

As an optional additional process, the range adjustment resulting from the above process could be monitored over a long period of time, e.g. several days, in order to reset the baseline range in case it is found that the range adjustment is consistently biased towards a positive or negative value. Such bias would indicate that traffic conditions tend to be lighter or heavier for certain APs in average. For example, one AP may be serving a conference room where a meeting is held every day. With the current process, the range adjustment of this AP would start from 0 dB in the morning and then would gradually go down, e.g. over 30 minutes to say −6 dB after the meeting starts, while the surrounding APs would go up to +6 dB. After the end of the working day all APs would gradually return to a range adjustment of 0 dB. Long term monitoring of the range adjustment, after identifying that trend, could readjust the baseline ranges by +/−6 dB so that the range adjustment doesn't need to be performed when the meeting starts every morning. This would improve the performance during the first 30 minutes of the meeting.

The power control process 105 is activated on a periodic basis, e.g., every half-minute or so. After the range adjustment (RNG_{adj}) parameter 135 is set, the range of the APs, AP1-AP7, are determined by summing the RNG_{base} 130 and RNG_{adj} 135. Referring to FIG. 3, as a result of the load balancing process 140, the range R2-R7 of the APs, AP2-AP7, is extended, and the range R1 of the center AP, AP1, is reduced. As a result, the WTRUs “O” now receive a signal above the RRP and experience a better downlink throughput. Some of the WTRUs “V” may re-associate to the boundary APs as a result of the stronger signals sent by them. Although the signals of the APs, AP2-AP7 are transmitted at a higher power level, this does not have severe consequences since they are lightly loaded and therefore do not generate a lot of interference. This is also compensated by the fact that the highly loaded center AP, AP1, now generates lower levels of interference.

The estimation periods for the load of the AP1 and the loads of the neighboring AP2-AP7, as well as the periodicity of the process, may be set to, for example, 30 seconds. This period is a compromise between the need for collecting a significant amount of load data on neighboring BSSs and the need of reacting reasonably quickly in case the load imbalance conditions deteriorate quickly, such as in a meeting-in-conference-room scenario.

The load balancing process can be performed together with other load balancing mechanisms implemented at the WTRU or the AP. It would be preferable that the WTRUs implement some sort of load balancing based on the noise or the traffic heard on each channel.

One potential problem with the proposed load balancing process is that overloaded APs that reduce their range may see their overload situation deteriorate if the WTRUs falling out-of-range do not re-associate to other APs, as the data rate to these out-of-range WTRUs may be reduced. Because of this, it may be necessary to implement a congestion control process that de-associates out-of-range WTRUs (or low-rate WTRUs) when the AP is overloaded, and denies association requests from out-of-range WTRUs.

One other aspect of the present invention is that, by controlling the transmission power of the beacon packet specifically, it is essentially ensures that WTRUs that are out-of-range are eventually forced to re-associate to other APs. Furthermore, there is less risk that WTRUs with no load balancing process incorrectly pick the overloaded AP (i.e., since it will not be able to hear the beacon or probe response packets).

Although the features and elements of the present invention are described in the preferred embodiments in particular combinations, each feature or element can be used alone without the other features and elements of the preferred embodiments or in various combinations with or without other features and elements of the present invention.

1. In a wireless communication system which includes a plurality of access points (APs) experiencing various loads, each AP being associated with at least one respective channel, a method of balancing the loads of the APs, the method comprising:
(a) estimating and comparing the load of each AP and the channel utilization of other channels not used by the AP to certain thresholds;
(b) increasing a range of a particular AP with a light load if the load on at least one channel used by another AP is heavy; and
(c) decreasing a range of a particular AP with a heavy load if the load on all channels not used by the particular AP is light.

2. The method of claim 1 wherein step (b) further comprises:
(b1) obtaining a baseline range of the particular AP;
(b2) calculating a range adjustment based on the results of the comparisons of step (a); and
(b3) adding the range adjustment to the baseline range to increase the range of the particular AP.

3. The method of claim 2 wherein the baseline range is based on path loss measurements.

4. The method of claim 1 wherein step (c) further comprises:
(c1) obtaining a baseline range of the particular AP;
(c2) calculating a range adjustment based on the results of the comparisons of step (a); and
(c3) adding the range adjustment to the baseline range to decrease the range of the particular AP.

5. The method of claim 4 wherein the baseline range is based on path loss measurements.

6. The method of claim 1 further comprising:
(c) establishing an adjustment repeat period; and
(d) repeating steps (a)-(c) according to the adjustment repeat period.

7. The method of claim 1 wherein the wireless communication system includes a plurality of wireless transmit/receive units (WTRUs) that communicate with the APs, wherein if any particular one of the WTRUs is determined to have an out-of-range status, the particular WTRU is disassociated with its current serving AP, and any association request received from the particular WTRU is denied.

8. The method of claim 1 wherein the wireless communication system is a wireless local area network (WLAN).

9. In a wireless communication system which includes a plurality of wireless transmit/receive units that communicate with a plurality of access points (APs) experiencing various loads, each AP being associated with at least one channel, a method of balancing the loads of the APs, the method comprising:
(a) estimating and comparing the load of each AP and the channel utilization of other channels not used by the AP to certain thresholds;
(b) obtaining at least one required received power (RRP) value associated with a minimum power level at which a particular type of packet transmitted by the particular AP is expected to be successfully received by a mobile station associated with the particular AP;
(c) determining an AP range adjustment value used to increase or decrease the range of the particular AP; and
(d) determining a transmission power level of the particular AP by summing the AP range adjustment values and the RRP value.

10. The method of claim 9 wherein a first RRP value is established for beacon and probe response packets, and a second RRP value is established for data packets.

11. The method of claim 9 wherein the RRP value is dependent upon a type and data rate of a transmitted packet.

12. The method of claim 9 wherein the RRP value is obtained either directly using a manual configuration or by an automated process.

13. The method of claim 9 wherein a range of a particular AP with a light load is increased if the load on at least one channel used by another AP is heavy.

14. The method of claim 9 wherein a range of a particular AP with a heavy load is decreased if the load on all channels not used by the particular AP is light.

15. The method of claim 9 wherein if any particular one of the WTRUs is determined to have an out-of-range status, the particular WTRU is disassociated with its current serving AP and any association request received from the particular WTRU is denied.

16. The method of claim 9 wherein the wireless communication system is a wireless local area network (WLAN).

17. An access point (AP) having a varying load, the AP comprising:
(a) means for estimating and comparing the load of the AP and the channel utilization of other channels not used by the AP to certain thresholds;
(b) means for increasing a range of the AP if the load of the AP is substantially lighter than the load on at least one channel used by another; and
(c) means for decreasing a range of the AP if the load of the AP is substantially heavier than the load on all channels not used the AP.

18. The AP of claim 17 wherein the means for increasing the range further comprises:
(b1) means for obtaining a baseline range of the AP;
(b2) means for calculating a range adjustment based on the results of the comparisons performed by the means for estimating and comparing; and
(b3) means for adding the range adjustment to the baseline range to increase the range of the particular AP.

19. The AP of claim 18 wherein the baseline range is based on path loss measurements.

20. The AP of claim 17 wherein the means for decreasing the range further comprises:
(c1) means for obtaining a baseline range of the AP;
(c2) means for calculating a range adjustment based on the results of the comparisons performed by the means for estimating and comparing; and
(c3) means for adding the range adjustment to the baseline range to decrease the range of the particular AP.

21. The AP of claim 20 wherein the baseline range is based on path loss measurements.

22. The AP of claim 17 further comprising:
(c) means for establishing an adjustment repeat period; and
(d) means for repeating the functions performed by the means for estimating and comparing, the means for increasing and the means for decreasing according to the adjustment repeat period.

23. An access point (AP) having a varying load, the AP comprising:
(a) means for estimating and comparing the load of the AP and the channel utilization of other channels not used by the AP to certain thresholds;
(b) means for obtaining at least one required received power (RRP) value associated with a minimum power level at which a particular type of packet transmitted by the particular AP is expected to be successfully received by a mobile station associated with the particular AP;
(c) means for determining an AP range adjustment value used to increase or decrease the range of the particular AP; and
(d) means for determining a transmission power level of the particular AP by summing the AP range adjustment values and the RRP value.

24. The AP of claim 23 wherein a first RRP value is established for beacon and probe response packets, and a second RRP value is established for data packets.

25. The AP of claim 23 wherein the RRP value is dependent upon a type and data rate of a transmitted packet.

26. The AP of claim 23 wherein the RRP value is obtained either directly using a manual configuration or by an automated process.

27. The AP of claim 23 wherein a range of a particular AP with a light load is increased if the load on at least one channel used by another AP is heavy.

28. The AP of claim 23 wherein a range of a particular AP with a heavy load is decreased if the load on all channels not used by the particular AP is light.

29. In a wireless communication system which includes a plurality of access points (APs) experiencing various loads, a wireless transmit/receiving unit (WTRU) comprising:
(a) means for disassociating from a first one of the APs which decreases its baseline range because it is experiencing a relatively heavy load as compared to other ones of the APs; and
(b) means for associating with a second one of the APs which increases its baseline range because it is experiencing a relatively light load as compared to other ones of the APs.

30. The WTRU of claim 29 wherein the wireless communication system is a wireless local area network (WLAN).

31. In a wireless communication system which includes a plurality of access points (APs) experiencing various loads, an integrated circuit (IC) comprising:
(a) means for disassociating from a first one of the APs which decreases its baseline range because it is experiencing a relatively heavy load as compared to other ones of the APs; and
(b) means for associating with a second one of the APs which increases its baseline range because it is experiencing a relatively light load as compared to other ones of the APs.

32. The IC of claim 31 wherein the wireless communication system is a wireless local area network (WLAN).

33. The IC of claim 31 wherein the IC is integrated into a wireless transmit/receive unit (WTRU).
